(19) United States
(12) Patent Application Publication
(10) Pub. No.: US 2012/0233839 A1
(43) Pub. Date: Sep. 20, 2012

(54) ARTICULATING SUPPORT FOR CONSTRUCTION MACHINE CONSTITUTING A QUICK RELEASE FASTENER AND RELATED MANUFACTURING METHOD

(75) Inventors: Serge MORIN, Lailly en Val (FR); Benjamin LECLERCQ, Beaugency (FR); Rene SIEFFERT, Odenas (FR)

(73) Assignee: Serge MORIN, Lailly en Val (FR)

(21) Appl. No.: 13/482,783

(22) Filed: May 29, 2012

Related U.S. Application Data
(62) Division of application No. 11/917,362, filed on Feb. 2, 2010.

(30) Foreign Application Priority Data
Jun. 14, 2005 (FR) 0505982

(51) Int. Cl. B23P 17/04

(52) U.S. Cl. 29/428

(57) ABSTRACT

An implement attachment is coupled to a working arm of a working machine. The arm is connected to an implement attachment by fastener sleeves and fastener pins. The attachment includes two side plates, each carrying two bushes having holes for accommodating the fastener pins. The bushes have a circular guide portion fitting into a circular hole in respective side plates. Each bush has a flange connected to the side plates by a fastener. The hole receiving the fastener pins is eccentric to the guide portion with respect to at least two of the bushes. As a result, the implement attachment is readily mounted on mutually different working arms.

For a given class of works machines, this present invention concerns the manufacture of an articulating support for a quick-release coupler pivoting at the end of the machine arm. The invention more particularly concerns a manufacturing method for an articulating support fixed to the machine arm, and intended to be connected to a quick-release coupler, where this method allows the key parameters of the kinematic motion to be varied easily. To this end, the objective of the invention is to create a wide range of supports that are compatible with the principle machines on the market, from a single basic part called the generic support.

In a known manner, machines of the hydraulic shovel type include, at the end of an arm, a deformable parallelogram driven by an actuator, which allows the rotation of the quick-release coupler holding the working tool of the machine.

From patent FR 2 657 596, awarded to Morin Frères, one is already familiar with a quick-release coupler device for the attachment of a bucket to a hydraulic shovel. Such a device is reliable and efficient, but has to allow for the large variety of dimensions and different kinematics of the articulated arms of hydraulic shovels.

From patent application FR 2 854 644, submitted by Morin SAS, one is already familiar with a quick-release coupler device composed of two distinct parts, which has at the top, firstly and invariant, a support to suit each machine in terms of distance between centres, diameters, and take-up devices.

These patents require the creation of a custom part designed for each model of hydraulic shovel, thus necessitating large stocks of parts and a large variety of parts dedicated to each machine, and take-up spacers in particular.

Document WO 99/06317 describes a tool support system connected to the tool arm, in which oblong orifices receive adapters that have the means of locking in rotation, and that are equipped with holes positioned so as to fix two cylindrical members at a desired distance. Such a system does not allow wide adaptation to different kinematics, since the orifices remain substantially parallel to the fitting and bolting plane of the tool.

Document JP 07 2179193 teaches a device of direct fastener which proposes a directional support with a torque limiter. This kind of device is distinguished from a fast fastener by the fact that clevis pins of the tool directly lock the fixing of the tool at the end of the hinged arm. Contrary to the quick fasteners described in the patents FR 2 657 596 or FR 2 854 644, which are locked and unlocked with the manner of a clipping/unclipping device, a device of direct fastener requires an operation of assembling/disassembling of the axes. In addition, bosses in extra thickness predetermine the position of connection bearings at the upper side of the device and rings for the reception of axis of connection to the work machine are inserted in these bearings.

This present invention has as its objective to propose an articulating support of a different design that allows faster and more economic production, and that offers improved adaptability while also allowing for the constraints of the rotation kinematic of the quick-release coupler around the machine arm.

In order to adapt the opening angle of the tool, the subject device of the invention proposes a position, in terms of angle and coordinates, that is designed for each machine of the machine class concerned.

To this end, the invention more particularly proposes an articulation support device composes of an invariable lower part for the class of machines, and intended for the attachment of a tool by the means described in patent FR 2 657 596 for example, and an upper part that includes two parallel lateral flanges having a constant separation that is determined for a class of works machines, which includes:
two pairs of orifices facing each other on the respective lateral flanges, placed at an angle and in coordinates according to the kinematic positions proper to each works machine;
adaptation bearings which are fitted by assembly means into the said orifices; and
two cylindrical members supported by the adaptation bearings, that include the means for locking in translation and/or in rotation so as to arrange for take-up of the lateral forces by the two flanges;
a top edge that is shaped according to the collision imperatives proper to each machine.

Thus, the invention proposes an articulating support device made from the subject generic support of the invention, which includes an invariable lower part for a given quick-release coupler system and an upper part that is specially designed for the kinematic of each machine by the position of the orifices in terms of angle and coordinates, and the shape of the top edge of the two flanges, whose form is designed for collision-free movement of the device around the machine arm.

According to another particular feature, the cylindrical members have at least one zone for reception of the tool arm of the machine, the extent in width of this reception zone being delimited and rendered smaller than the separation between the flanges, by the adaptation bearings. These cylindrical members are immobilised in translation and/or in rotation by the said adaptation bearings, and thus contribute to the mechanical strength of the flanges and of the whole of the support.

According to another particular feature, the lower part includes at least one transverse bridge element used to connect the lateral flanges in a rigid manner.

Another objective of this present invention is to propose a manufacturing method of an articulating support used, for a given class of machines, to simplify the production flow of equipment intended for public-works machines.

To this end, the invention proposes a manufacturing method for an articulating support device that includes, in an upper part, two lines of articulated axles on the tool arm of a works machine, with the lower part of this support being designed to attach a tool in a removable manner, the said method being characterised in that it includes:
a step for the manufacture of an articulating generic support, equipped:
   in an upper part with two opposing lateral flanges each with a sufficient area to allow the creation of connecting orifices with dimensions that are proper to each works machine and that are variable for the class of machines, and
   in a lower part with of the means of connection proper to a quick-release coupler;
a first step of specialisation that includes a second machining to an upper part of the generic support in order to form, on each flange, a new top edge to suit the movement of the support around the machine arm;
a second step for the creation of two pairs of orifices divided between the lateral flanges above the new top edges, and whose position on the flanges is designed for the movement proper to each machine for which the device is intended;
a third step of specialisation, which includes the fitting, through the respective pairs of orifices, of two cylindrical members of the same predetermined length, by means of adaptation bearings fitted with the means for locking the cylindrical members in translation and/or rotation.

The method thus allows the manufacture of an articulating support from a generic part that is identical for a given class of machines, with the axles and the take-up devices being unified, and with the width and movement around the arm being adjusted for each machine only by the size and the position, in terms of angle and coordinates, of the adaptation bearings, and by a new edge machined by the removal of material from the upper part of the flanges.

According to another particular feature, the method includes a machining step on the lower part to form means proper to a quick-release coupler system.

According to another particular feature, the preparation or machining step in the lower part is effected from the non-specialised generic support part.

The characteristics and advantages of the invention will emerge more clearly on reading the description that follows, with reference to the appended drawings in which:

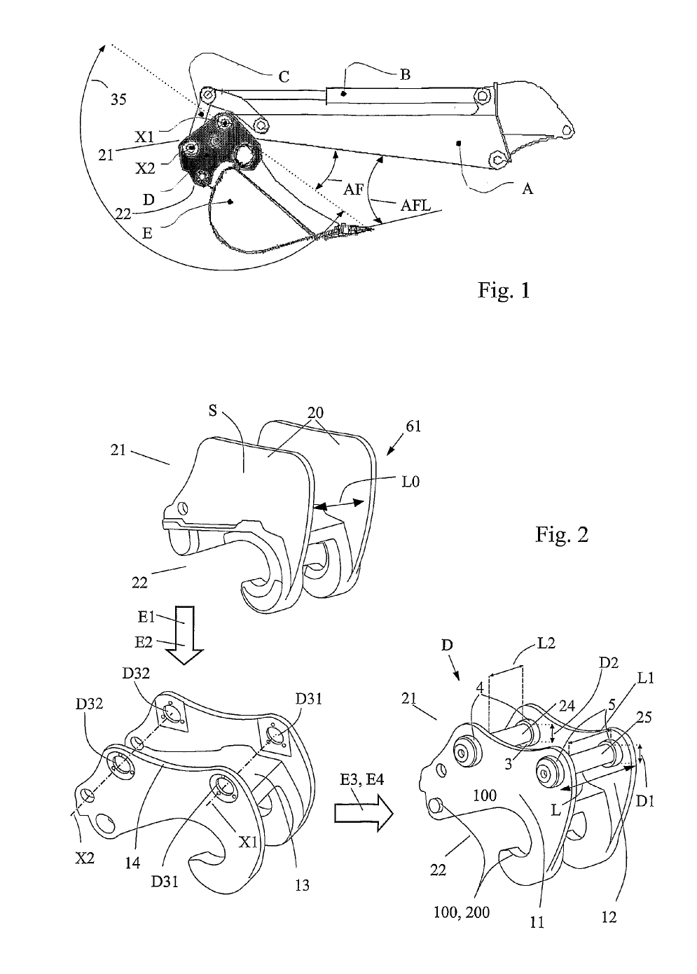

FIG. 1 shows the device according to the invention connected to the machine arm, and the possible movement of the quick-release coupler and tool assembly in operation;

FIG. 2 illustrates three successive stages of manufacture according to the invention, going from a generic basic part to a specific articulating support forming a quick-release coupler;

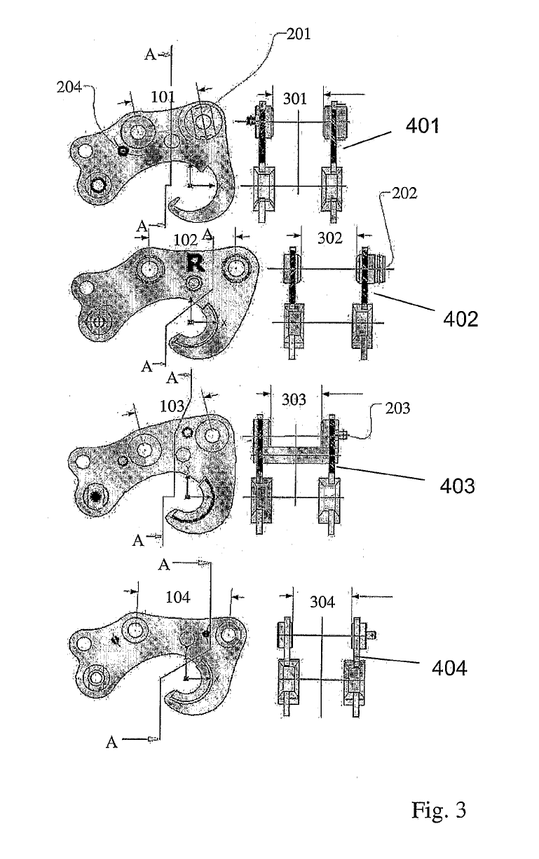

FIG. 3 illustrates, in a view in profile and in section, the previous designs for several rapid couplers for a given class of machines, to illustrate their diversity;

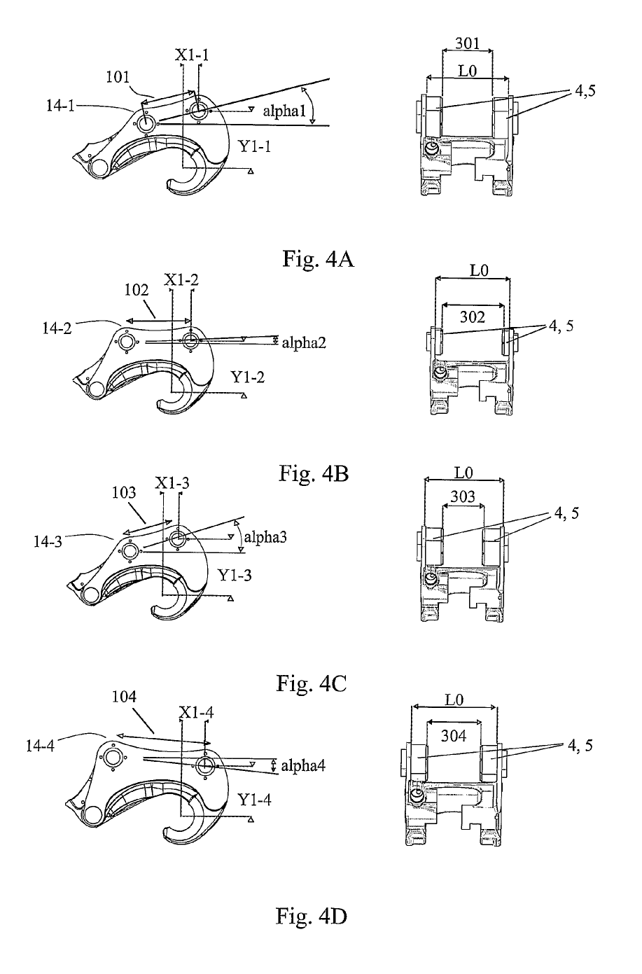

FIGS. 4A, 4B, 4C and 4D show respective views in profile and elevation of quick-release couplers created using the method of the invention, with each of the couplers having orifice positions that are identical to those of FIG. 3 and a new top edge designed for specific movement kinematics;

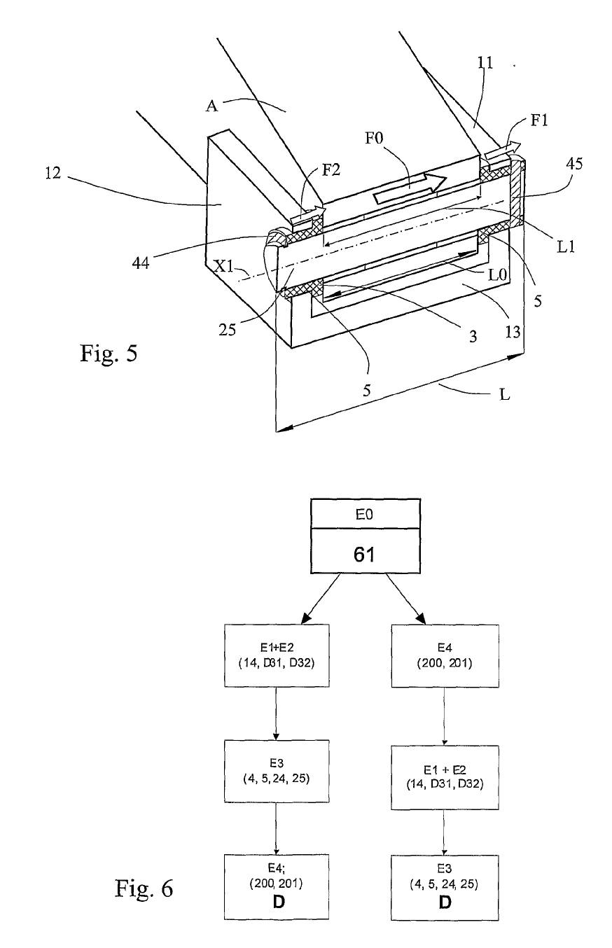

FIG. 5 is a view in section of the connection to the arm of an articulating support according to the invention, and the division of the forces between the two flanges;

FIG. 6 is a flow diagram for the steps of manufacture of an articulating support according to two preferred embodiments of the invention;

The invention will now be described with reference to FIGS. 1 to 4.

In a known manner, hydraulic shovels or similar machines include, at the end of an arm (A), a deformable parallelogram driven by an actuator (B), that allows the rotation of the tool (E) by means of the articulating support (D). FIG. 1 illustrates an example of movement (35) that is possible for such an assembly, namely a quick-release coupler and tool. The type of articulating support (D) envisaged in the invention includes a top support part (21) having a first means of attachment to render the device (D) mobile in rotation around a first axle (X1), and a second means of attachment arranged on a second axle (X2) parallel to the first axle (X1) to receive at least one element (C) for driving the device (D) in rotation. The upper part (21) is attached to a lower part (22) that is intended to attach a tool (E). It can be seen easily that the relative positions of the axles X1 and X2 in relation to the tool (E) have a direct influence on the movement (35) and the characteristic angles (AF) and (AFL).

In the embodiment of FIG. 2, the lower part (22) of the articulation device (D) includes means proper to the quick-release coupler system described in patent FR 2 657 596. The support then constitutes the attachment device of a quick-release coupler. The objective of the invention is firstly to incorporate, into the articulating support (D), the cylindrical members (24, 25) forming geometrical axes (X1 and X2), and to unify the associated take-up spacers for a class of machines, and secondly to create a generic casting shape or a generic form of re-worked welded element to fit the model of the works machine concerned, so that the variation in the products is limited to the following:
the shape of the bearings (4, 5), determined to adjust the diameter (D1, D2) and the internal width dimension (L1, L2) for the connection to the machine tool arm;
the position of the bearings (4, 5) in the generic shape, determined to match the kinematic and movement angles (AF, AFL, 35);
the external connection shape of the flange (11, 12) determined to avoid any collision during the movement of the device (D) around the machine arm.

As illustrated in FIG. 3, it was observed by the inventors, on the products of previous design, that for a given range of works machines, the dispersion of the distance between centres (101, 102, 103, 104), of the widths between the two flanges (301, 302, 303, 304), and of the take-up spacer systems (201:groove; 204:pins; 202: collar; 203: threaded pin) was very large.

This diversity constitutes the most marked point of variation, in industrial terms, in the production of an articulating support (D). In addition, the shape and the separation of the flanges (401, 402, 403, 404) are currently designed for each separate model. In order to allow mass production, the invention proposes a new manufacturing method that adapts the articulating support (D) to the dimensions of the machinery arm (A) in the simplest manner possible.

FIGS. 4A to 4D again respectively illustrate the attachment devices of FIG. 3, with each of the attachment devices of FIGS. 4A to 4D being one particular example of a device according to the invention. In order to achieve the kinematic characteristics, it will be seen that the position of axle X1 varies in terms of coordinates (X1-1; Y1-1) to (X1-4; Y1-4) and angle (respectively alpha1, alpha2, alpha3, alpha4) for each attachment device. In order to achieve the top edge imposed by the collision with the tool arm, the top edges (14-1 to 14-4) are re-machined specifically. It will also be seen that the new internal width of the flanges (L0) is constant for the whole of the range.

According to a preferred embodiment of the invention, the articulating support device (D) shown in FIG. 2 is equipped with adaptation bearings (4, 5) that are used to support and guide the cylindrical members (24, 25) forming the first and second means of attachment to the works machine. Each cylindrical member (24, 25) is of a specified diameter (D1, D2) and passes through the two opposing lateral flanges (11, 12) of the support device (D). For example, the cylindrical members are of a given predetermine length (L) that is greater than the separation (L0), designed to be constant, between the flanges (11, 12).

The articulating support (D) of the invention advantageously includes two pairs of orifices (D31, D32), divided between the lateral flanges (11, 12), with a diameter (D31, D32) greater than the specified diameter (D1, D2) of the cylindrical members (24, 25) associated with them. Thus, the adaptation bearings (4, 5) guarantee the position of the cylindrical members (24, 25) in the pairs of orifices (D31, D32). The support (D) also includes the means for attachment of each adaptation bearing (4, 5) onto the sides (11, 12) in the orifices (D31, D32).

As illustrated in FIG. 5, the adaptation bearings (4, 5) include the means (44, 45) for locking, in translation and/or in rotation, of the cylindrical members (24, 25). According to the illustrated embodiment of the invention, the locking means (45) is a penetrating elastic cotter pin that immobilises the member (25) in rotation and in translation, with means (44) limited to immobilisation in translation by means of an elastic ring fitted in a groove created in the cylindrical member (25).

Each adaptation bearing (4, 5) includes a shoulder portion (3) facing inwards and used to form, for each axle (X1, X2), a free length (L1, L2) of the cylindrical member (24, 25) corresponding to the width of the machine arm, and less than the separation (L0) between the flanges (11, 12). In other words, the internal width (L1) necessary for fitting the articulating support device (D) onto the articulated arm (A), is achieved by varying the thickness of the shoulder (3) on the bearings (4, 5). Likewise, the second internal width (L2) can be different from the first internal width (L1).

With reference to FIGS. 1 and 2, the bearing articulated arm (A) is mounted to rotate freely on a first cylindrical member (25) and the rotational drive element (C) is mounted to rotate freely on the second cylindrical member (24).

Although most manufacturers' axles include a take-up spacer device on one side only, the axles associated with this present invention include locking means (44, 45) associated with or incorporated into the bearings (4, 5). A lateral force (F0) transmitted by the arm (A) onto the articulating support device (D) will be taken up by the respective forces (F1, F2) on the flanges (11, 12). In the case of a take-up spacer device on one side only, the lateral force (F0) would be completely taken up by only one of the flanges, with the member (24, 25) being incapable of transmitting any axial force. These locking means (44, 45) are used to clamp the flanges (11, 12) and thus contribute to the strength and rigidity of the assembly formed by the cylindrical members, the flanges and the bridge element (24, 25, 11, 12, 13).

Referring to FIGS. 1 and 2, the upper support part (21) includes, above the pairs of orifices (D31, D32), a new longitudinal edge (14, FIG. 2) of the flanges (11, 12), designed to avoid any collision with the machine arm during movement. These new edges are advantageously achieved by a second machining of an upper part (20) of the articulating generic support (61).

Referring to FIGS. 2 and 6, the manufacturing method includes:
a step (E0) for the manufacture of a generic support (61) equipped with two opposing lateral flanges (11, 12), each with a sufficiently large area (S) to allow the creation of articulation supports of dimensions that vary according to the constraints associated with the articulated arm (A) of the public works machine;
a first specialisation step (E1) that includes a second machining operation on an upper part (20) of the generic support (61) in order to form, on each flange, (11, 12) a new top edge (14) designed to allow collision-free movement of the support device (D) around the arm on axle (X1);
a second specialisation step (E2) that includes the creation of two pairs of orifices (D31, D32), divided between the lateral flanges (11, 12) above the top edges (14), resulting from the second machining, to form an intermediate part;

- a third specialisation step on the piece created by machining of the connection means (100, 200) of the lower part (22);
a fourth specialisation step (E4) that includes the fitting, through the pairs of orifices (D31, D32), of the adaptation bearings (4, 5) and of two cylindrical members (24, 25) of the same predetermined length (L), and the means for locking (44, 45), in translation and/or rotation, of the cylindrical members.

According to another particular feature, the method includes a step for machining (E3) of the lower part (22) to form means (100, 200) proper to a quick-release coupler system.

Naturally, the sequencing of the specialisation steps can be altered, and the machining and preparation (100, 200) of the lower part (22) can, for example, be shaped directly on the generic part (61), upstream of steps E1 and/or E2. Such a sequence of steps is used to constitute a “primary” machining reference that can then be used for the later steps.

One of the advantages of the articulating support devices (D) created by the method of the invention is the ability to adapt to a large variety of kinematics. Each device (D) is constructed specifically according to the kinematic of the tool, in particular by varying the position of the orifices (D31, D32).

It should be obvious to those practised in the art that this present invention allows its implementation in many other specific forms while still not moving outside the scope of the invention as claimed.

1. A method of manufacturing an articulating support device that includes, in an upper part, two lines of axles associated with the tool arm of a public works machine, with the lower part of this support being removably attached to a tool, the method including:
manufacturing a one-piece unit of a generic articulation support, equipped with two opposing lateral flanges, each with a sufficiently large area to allow creation of connecting orifices that are proper to each works machine and variable to suit the class of machines;
a first specialisation step performed on the generic support and that includes re-machining an upper part in order to form, on each flange, a new top edge that allows collision-free movement of the support device around the arm on the connecting axle to the works machine;
a second specialisation step including drilling, in the support emerging from the first specialisation step, two pairs of orifices divided between the lateral flanges above the top edges, and whose positioning in terms of angle and coordinates on the flanges depends on the kinematic of the machine for which the device is intended;
a third specialisation step including machining the lower part of the support emerging from the second specialisation step, of a connection means;
a fourth specialisation step including fitting, to the support obtained from the third specialisation step, through the respective pairs of orifices, of two cylindrical members of the same predetermined length, by using adaptation bearings, and locking means, in translation and/or rotation, of the cylindrical members.

2. A method according to claim 1, further including machining the lower part to form means proper to a quick-release coupler.

3. A method according to claim 1, wherein the third specialisation step of the lower part is effected from the generic support before the other specialisation steps.
